(19) United States
(12) Patent Application Publication
(10) Pub. No.: US 2015/0030817 A1
(43) Pub. Date: Jan. 29, 2015

(54) Method for Producing a Panel Having a Decor and a Three-Dimensional Structure

(71) Applicants: Andre Wiegelmann, Olsberg (DE); Johann Dürnberger, Kirchdorf/Tirol (AT)

(72) Inventors: Andre Wiegelmann, Olsberg (DE); Johann Dürnberger, Kirchdorf/Tirol (AT)

(73) Assignee: FRITZ EGGER GMBH & CO. OG, Unterradlberg (AT)

(21) Appl. No.: 13/809,623

(22) PCT Filed: Jun. 6, 2011
(86) PCT No.: PCT/EP2011/059286

§ 371 Date: Mar. 28, 2013

(30) Foreign Application Priority Data
Jul. 16, 2010 (DE) 102010036454.1

(51) Int. Cl. B44F 9/02; B05D 1/02; B05D 3/10; B05D 1/28; B05D 3/06; B05D 1/12; B05D 1/40

(52) U.S. Cl. CPC B44F 9/02; B05D 1/12; B05D 1/02; B05D 1/40; B05D 1/28; B05D 3/06; B05D 3/107
USPC 428/195.1; 427/256; 427/557; 427/278

(57) ABSTRACT

The invention relates to a method for producing a panel, in particular a furniture or floor panel, wherein a decor, preferably a wood imitating decor, is applied to at least one surface of a plate-shaped substrate, and wherein the substrate or the decor is provided with an areal, three-dimensional structure. The method is substantially characterised in that to produce the structure, liquid and/or powdery application material is applied in a single layer or multiple layers to the substrate or the decor, in that the application material applied is solidified in regions by means of at least one digitally controllable device, and in that the device is controlled using structural data present in digital form.

The invention relates to a method for producing a panel, in particular a furniture or floor panel, in which a decor, preferably a wood imitating decor, is applied to at least one surface of a plate-shaped substrate, and in which the substrate or the decor is provided with an areal, three-dimensional structure. Furthermore, the invention relates to a panel produced by a method of this type, in particular a furniture or floor panel.

Various methods are known, with which laminated panels, in particular floor panels, are produced from wooden composite boards. A known method consists, for example, in laminating wood fibre boards or chipboards with printed and melamine resin-impregnated decor paper and then providing them with a structured surface in a press using a structured metal embossing sheet. The decor paper is generally printed with a wood imitation, for example a strip parquet or wooden floor board pattern. The embossed structure is intended to imitate the pore structure of natural wood. In particular, it is known in this context to match a wood imitating decor and a structured metal embossing sheet to one another, so that the structure embossed with the metal embossing sheet is configured as synchronously as possible with the wood imitating decor, i.e. the structure runs, as far as possible, so as to overlap the associated wood imitating decor with a precise fit. The appropriate alignment of the metal embossing sheet in relation to the decor paper is difficult, however. In addition, the problem exists here that the dimensions of the decor paper change under the action of pressure and temperature in the press. This is referred to as paper growth.

Another known method for producing a three-dimensionally structured surface on a plate-shaped workpiece consists in printing a decor, in particular a wood imitating decor, directly onto the plate-shaped workpiece by means of printing rollers and then applying a transparent sealing layer to the decor by applying a flowable medium using an engraved application roller. Although the problem of paper growth is avoided by this procedure, the quality of the structuring produced in this way, in particular the structural depth achieved by means of the application roller, in relation to the relatively fine structurings is still unsatisfactory.

To achieve a structural depth of significantly more than 10 μm (micrometres), for example a structural depth of 50 μm, a method is proposed in DE 10 2007 019 871 A1, in which the application of the flowable medium takes place by means of an engraved application roller in such a way that the application roller is wetted both in its engraved indentations and in the (non-engraved) elevated regions with the flowable medium. A three-dimensional structure having a structural depth of 5 to 500 μm should be achievable in this manner. However, it is disadvantageous in this known method that at least one engraved decor printing roller and an associated engraved application roller are required for each wood imitating decor to produce the surface structure. Production of panels with different wood imitating decors, in particular changing the decor printing rollers and the application rollers producing the three-dimensional structure, is very laborious.

Furthermore, a method for producing a panel having a three-dimensional surface lamination is known from DE 10 2005 046 264 A1, in which the upper side of a wooden composite board laminated with a printed decor paper is provided with an unprocessed pore layer, i.e. a layer actually having no pores, into which pores are subsequently engraved—optionally after curing—by means of laser processing. Furthermore, a method variant is proposed in DE 10 2005 046 264 A1, in which a wood fibre board is firstly provided with a thermosetting primer coating, in which a pore structure is then engraved by a laser. A complete decor is then applied by means of a digital printing device, in particular an inkjet printer.

The present invention is based on the object of disclosing a method of the type mentioned at the outset, with which high-quality decorative panels having a three-dimensional surface structure can be produced economically, even in relatively small quantities.

According to the invention, this object is achieved by the method having the features of claim 1.

In the method according to the invention, a decor, preferably a wood imitating decor, is applied to at least one surface of a plate-shaped substrate. Furthermore, the substrate or the decor is provided with an areal, three-dimensional structure. The three-dimensional structure may also be applied in this case, in particular, before the application of the decor to the substrate. Likewise, the three-dimensional structure may, however, also only be applied after the application of the decor thereto. According to the invention, liquid and/or powdery application material is applied in a single layer or in multiple layers to the substrate or the decor to produce the structure, the application material applied being solidified in regions by means of at least one digitally controllable device, and the device being controlled using structural data present in digital form.

Three-dimensional structures with a large structural depth can be produced by the method according to the invention. This applies, in particular, when the liquid and/or powdery application material is applied in a plurality of layers to the substrate or the decor. In particular, in relation to the respective decor surface, various surface regions of the respective panel can thus be produced with a different structural height and/or structural depth. By using a digitally controllable device and the control thereof by means of structural data present in digital form, panels having different decors, in particular wood imitating decors, stone imitating decors and fantasy decors, can be produced on a single production system, without a laborious exchange of an application roller or a metal embossing sheet being necessary upon a change of the decor. The use of digital structural data and a device that can be digitally controlled therewith to apply, compress and/or solidify the application material allows, in particular, an economical, flexibly variable production of panels having different individual decors or structures, this being in different formats and different batch sizes. Moreover, the production according to the invention of the three-dimensional structure, in which preferably no material application takes place at the locations of later indentations of the structure or else excess application material can be removed at these locations and reused, allows a considerable material saving compared to conventional methods, in which the pores (indentations) are produced by burning away, displacing or compressing application material.

A preferred embodiment of the method according to the invention provides that a liquid and/or powdery application material is used as the application material and solidifies under the action of radiation, preferably light and/or thermal radiation, the application material applied to the substrate or the decor being solidified in a locally limited manner in the region of the structure to be produced by supplying said radiation.

A further embodiment of the method according to the invention consists in that a liquid and/or powdery application material is used as the application material and solidifies under the action of a binder, the application material applied to the substrate or the decor being solidified in a locally limited manner in the region of the structure to be produced by supplying said binder.

The method according to the invention comprises, in particular, an embodiment variant, in which the liquid and/or powdery application material is applied in a targeted manner substantially only in the region of an elevation to be produced of the three-dimensional structure in a plurality of layers. Alternatively, the application material being used to produce a three-dimensional structured may, however, also be applied according to the invention with a clear excess or even over the entire area, a locally limited solidification of the application material to produce elevations of the three-dimensional structure then being carried out. After the locally limited solidification of the application material, non-solidified, excess application material is then removed from the plate-shaped substrate. The excess application material is preferably reused to produce further structural portions.

A further advantageous embodiment of the method according to the invention is characterised in that the decor is printed on the plate-shaped substrate by means of a digital printing device. As a result, a high degree of flexibility with respect to a production of panels having various decors and three-dimensional structures, different formats and different batch sizes, is made possible.

A further advantageous embodiment of the invention in this context consists in digital decor data for controlling the printing device being obtained by scanning patterns produced from natural products, preferably real wood or natural stone. As a result, a large number of different decors can easily be recorded and stored in a memory as digital data sets to control the printing device. In a further embodiment of the method according to the invention, it is provided that the structural data to control the digital device, which brings about the application, compression and/or solidification of the application material, are also obtained by scanning patterns produced from natural products, preferably real wood or natural stone. As a result, an optimal fitting precision (synchronicity) of the decor and three-dimensional structure can be achieved.

An optimal fitting precision of the decor and three-dimensional structure can also be achieved in a further embodiment of the method according to the invention if the structural data for controlling the digital device, which brings about the application, compression and/or solidification of the application material, are obtained by scanning the decor optionally applied beforehand to the plate-shaped substrate.

A further advantageous embodiment of the method according to the invention is characterised in that the application material applied is solidified in regions by means of a plurality of digitally controllable devices, the devices covering different surface regions of the substrate. This configuration allows a substantial increase in productivity in the production according to the invention of the three-dimensional structure.

The invention will be described in more detail below with the aid of drawings showing a plurality of exemplary embodiments in which, schematically:

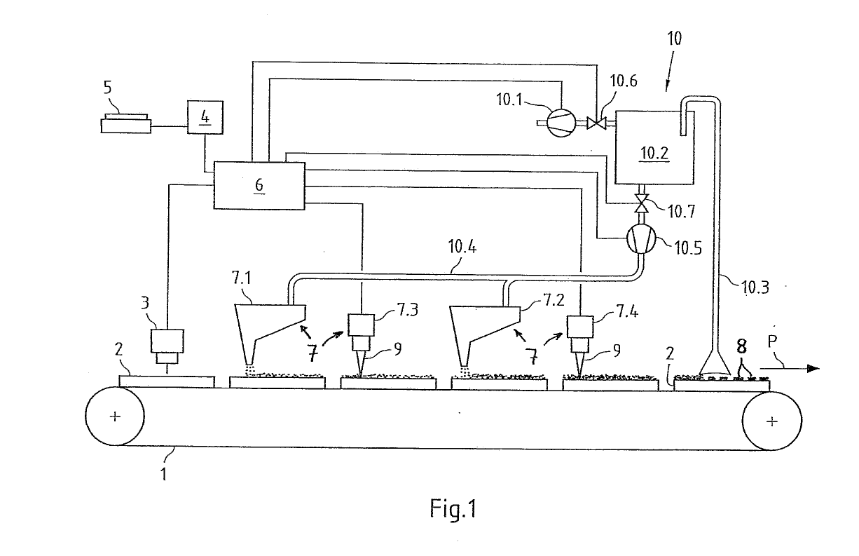

FIG. 1 shows a device for carrying out the method according to the invention;

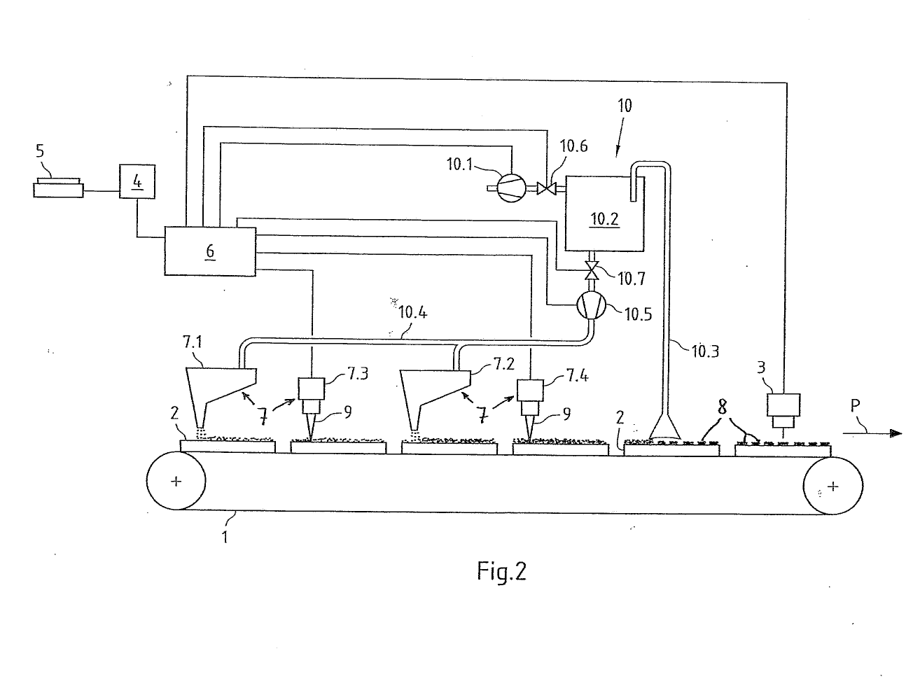

FIG. 2 shows a further device for carrying out the method according to the invention;

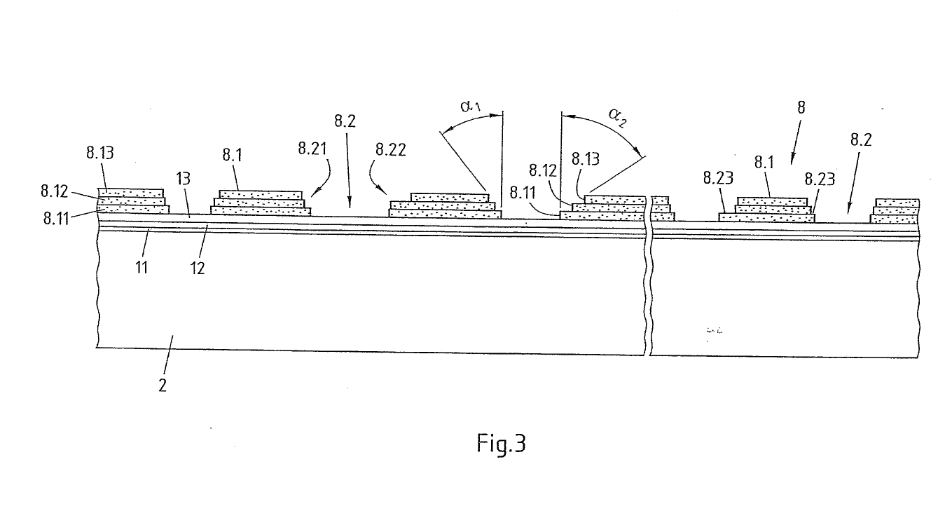

FIG. 3 shows a panel produced by the method according to the invention in a vertical longitudinal sectional view; and

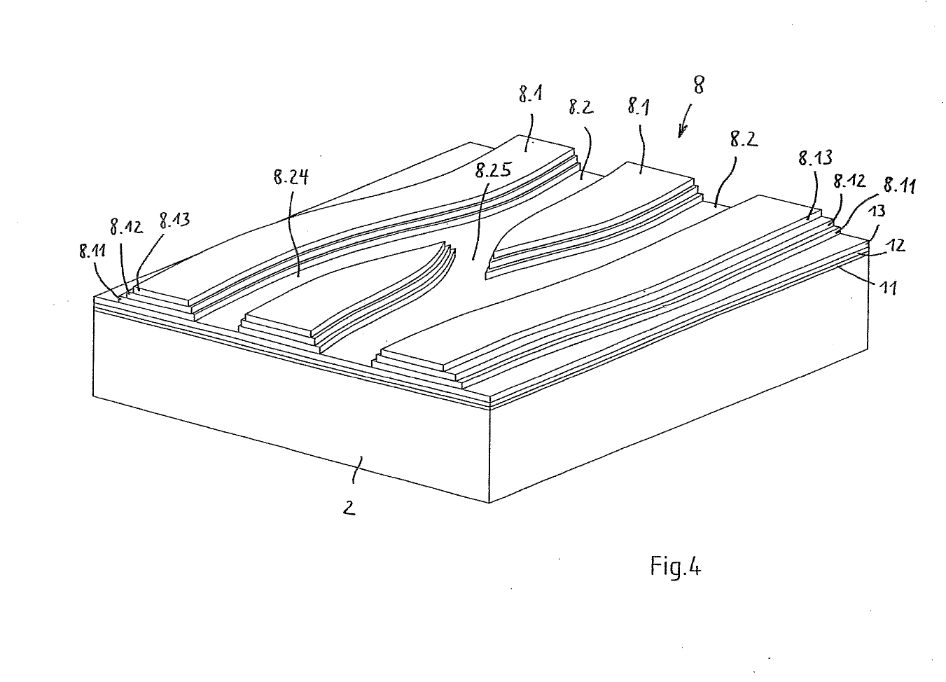

FIG. 4 shows a portion of a panel produced by the method according to the invention in a perspective view.

The device shown in FIG. 1 comprises a conveyor device 1, for example a conveyor belt system, by means of which plate-shaped substrates 2 to be provided with a decor and a three-dimensional structure are supplied to a plurality of processing stations. The transport direction of the substrates 2 is indicated by the arrow P.

The plate-shaped substrates 2 consist, for example, of wooden composite boards, for example of medium-density or high-density wood fibre boards. The surface of the respective substrate 2 to be provided with the decor is firstly provided with a primer. The primer is used to reduce the absorption capacity of the substrate board 2 and improves the adhesion of a subsequently applied decor. The primer is colour-matched to the decor to be applied. For example, the primer has a beige or reddish colour if the decor to be applied is an oak or a cherry wood decor. If, on the other hand, a stone decor is applied, the primer may, for example, have a grey colour shade. The primer applied to the plate-shaped substrate 2 is preferably solidified by means of light and/or thermal radiation and then sanded in a further processing station (not shown).

The plate-shaped substrates 2, which have been pretreated in this manner, are supplied to a printing device for application of the decor. The printing device preferably comprises at least one digital printing device 3, for example a printing device configured according to the operating principle of an inkjet printer.

The digital printing device 3 is controlled by means of digital decor data, which are stored or can be stored in a data memory 4, preferably a central data memory. The digital decor data (control data) are preferably obtained by the scanning (optical scanning) of samples. The samples are, in particular, patterns (original patterns) produced from natural products, for example real wood or natural stone. For this purpose, a high-resolution scanner 5 is used. The decor data thus obtained are stored in the data memory 4 and transmitted as control signals by a control device 6 to the printing device 3. In this case, it is also within the scope of the invention to process the decor data obtained or stored beforehand. This processing may, for example, comprise a revision of the decor data with regard to eliminating defective locations of the original sample taken as a base, for example knotholes and/or inclusions. Furthermore, the processing of the decor data may comprise changing the colour shade and/or the colour contrast.

A drying device (not shown), by means of which the decor applied to the respective board 2 is at least partially solidified, may follow the printing device 3. The drying or solidification optionally takes place in turn by means of light and/or thermal radiation.

Furthermore, an application device (not shown), by means of which a transparent, substantially uniform sealing layer is applied to the decor over the entire area, may follow the printing device 3.

The decor, which has been printed on (and optionally sealed over the entire area) is then provided with an areal, three-dimensional structure. According to the invention, the structure 8 is produced by a single-layer or multi-layer application of application material (cf FIG. 3). This takes place by means of a digitally controllable device 7, which is controlled using structural data present in digital form.

The structural data are in turn obtained by the scanning (optical scanning) of patterns produced from natural products, for example real wood or natural stone, and are stored in the data memory 4.

The transmission of the decor data and the structural data from the data memory 4 to the printing device 3 and the digital device 7 for producing the three-dimensional structure takes place by means of a data network, for example an intranet or the internet, or by means of a mobile/transportable data storage medium, which may be connected to the printing device 3 or the digital device 7 or read into and from an associated data reader (not shown).

In the embodiment according to FIG. 1, a powdery application material, which can be solidified by light and/or thermal radiation and can be applied using a digitally separately controllable device, is used as the application material to produce the three-dimensional structure 8.

The three-dimensional structure 8 is produced from transparently curing material. As shown in FIG. 3, the structure 8 defines small elevations 8.1 and indentations (pores) 8.2, the positions of the elevations 8.1 and indentations 8.2 being matched to the decor. Thus, for example, corresponding indentations (pores) of the structure are arranged to fit precisely for example on locations of a wood imitating decor representing wood pores. These are referred to as synchronous pores or a synchronous pore structure.

The three-dimensional structure is preferably produced layer-wise by means of a digitally controllable device 7 using structural data present in digital form. The device 7 for this purpose comprises a (first) application head 7.1 following the printing device 3 for powdery application material, which solidifies under the action of light and/or thermal radiation.

The device 7 preferably comprises two, three or more such application heads 7.1, 7.2. The respective application head 7.1, 7.2 is combined with a device 7.3, 7.4 for solidification of the liquid application material.

By means of the application head 7.1 configured as a spreading head in FIG. 1, a first layer of powdery application material is applied, substantially over the entire area, to the upper side of the respective plate-shaped substrate 2 that is printed with the decor. A processing station having a processing head 7.3, which directs a focused energy beam 9, for example a laser beam, onto specific part-regions of the application material applied, is arranged downstream of the spreading head 7.1.

This means that the application material applied to the decor is solidified in a locally limited manner in the region of the structure to be produced by supplying said light and/or heat radiation.

A second or further application head (spreading head) 7.2 for applying a second or further layer of the powdery application material may follow the processing head 7.3, which application material is then in turn melted or solidified in a locally limited manner by means of an energy beam 9, which is radiated by processing head 7.4 following the spreading head 7.2 in the transport direction P of the substrate boards 2. In order to achieve a solidification of the powdery application material by the action of light, the latter contains, for example, a photopolymer.

The processing head 7.3, 7.4, for example, a laser head, may be moved both in the transport direction P of the plate-shaped substrates 2 and transverse to the transport direction. The movement and function of the respective processing head 7.3, 7.4 are controlled depending on the stored structural data by means of a control device 6.

The excess application material that has not solidified after the locally limited solidification or melting of the application material is removed from the respective plate-shaped substrate 2. This preferably takes place by means of an extraction device 10. The extraction device comprises for this purpose, for example, a suction fan 10.1, a collecting container 10.2 and an extraction line 10.3 leading to the collecting container. The suction opening of the extraction line 10.3 is arranged at a small spacing above the coated substrate 2. The application material extracted from the substrate 2 and collected in the collecting container 10.2 can be reused for producing further layers or portions of the three-dimensional structure of the panels to be produced. Accordingly, a return line 10.4, which is provided with a screw conveyor 10.5 or another suitable conveyor, is connected to the collecting container 10.2. The return line 10.4 opens into at least one feed or storage container, which is associated with the spreading head 7.1 or 7.2. Arranged between the collecting container 10.2 and the suction fan 10.1 is a valve or shut-off means 10.6. Likewise, arranged between the collecting container 10.2 and the pump (screw conveyor) 10.5 is a valve or shut-off means 10.7. The valves (shut-off means) 10.6, 10.7 can be controlled in opposite directions, i.e. when the valve 10.6 is open, the valve 10.7 is closed and vice versa.

The application material, from which the three-dimensional structure is produced by means of a single-layer or multi-layer application, is a lacquer or synthetic resin, which cures transparently. The application means may contain, in this case, particles which increase abrasion resistance, for example corundum particles. The particles which increase abrasion resistance do not have to be applied here with each of the application heads 7.1, 7.2. For example, the application material applied by the first application head 7.1 may contain no particles which increase abrasion resistance, while the application material, which is applied by the second and/or the last application head 7.2 does contain such particles.

After the production of the three-dimensional structure, the respective plate-shaped substrate 2 is divided into a plurality of panels. This takes place, for example, by means of a sawing device (not shown) having a plurality of saw blades. Furthermore, an edge processing of the panels is also provided, during which at least their longitudinal edges are provided by milling with connecting elements, for example tongue and groove elements.

FIG. 2 schematically shows a further embodiment of a device for carrying out the method according to the invention. This device differs from the device according to FIG. 1 in that the at least one digital printing device 3, which is controlled by means of digital decor data, is arranged downstream of the at least one digital device 7 for producing a three-dimensional structure in the transport direction P of the plate-shaped substrates 2. In this embodiment, a three-dimensional structure is therefore firstly produced on the substrate 2 and then a decor, for example a wood or natural stone imitating decor, is printed by means of the digital printing device 3 on the three-dimensional structure.

With regard to the construction and operation of the digital printing device 3 and the obtaining and processing of the decor data, reference is made to the above statements to avoid repetition.

In the embodiment shown in FIG. 2 of a device for carrying out the method according to the invention, the possibility exists of dispensing with a priming of the plate-shaped substrate 2 or using application material simultaneously having priming properties as the application material to produce the three-dimensional structure.

The application material applied to the substrate 2 before the decor and solidified in regions to produce a three-dimensional structure by means of at least one digitally controllable device 7 is colour-matched to the decor. For example, the application material, after its region-wise solidification, has a shade which is beige or reddish in colour, if the subsequently printed-on decor is a wood imitating decor.

The device 7 shown in FIGS. 1 and 2 is, for example, configured in such a way that it works by the multi-pass method. Alternatively, the device 7 may, however, also be configured in such a way that it works by the single-pass method. In the single-pass method, a plurality of devices 7 or 7.3 and/or 7.4 are present, which are arranged next to one another in the transport direction P of the substrate 2 and, in each case, cover a specific working width, i.e. different surface regions of the plate-shaped substrate 2. In the multi pass method, on the other hand, at least one device 7 or 7.3 and/or 7.4 is provided, which is moved across the workpiece surface, the feed of the substrate 2 taking place in a virtually clocked manner here.

FIG. 3 schematically shows a panel produced by the method according to the invention in a vertical longitudinal sectional view. The panel consists of a wooden composite board 1, for example a chipboard or a wood fibre board. A primer layer 11 is firstly arranged on the visible side of the wooden composite panel 1 being used as a substrate. A decor, for example a coloured wood imitating decor, stone imitating decor or fantasy decor is printed on the primer layer 11. The decor forming a relatively thin layer 12 is sealed with a transparent protective layer 13. The structure 8 composed of a plurality of layers 8.11, 8.12, 8.13 is applied to the protective layer (sealing layer) 13. The layers 8.11, 8.12, 8.13 of the three-dimensional structure 8 also consist of transparent material, for example a transparently-curing synthetic resin or lacquer. Corundum particles or the like which increase abrasion resistance may be embedded at least in the uppermost layer 8.13. Owing to the multi-layer construction of the structure 8, it is not only possible to produce decorative panels of the type mentioned with a relatively large structural depth. As illustrated in FIG. 3, the method according to the invention also allows a very variable configuration of the flanks 8.21, 8.22 of the indentations (pores) 8.2. The pore flanks 8.21, 8.22 may be made particularly steep by the multi-layer construction of the structure 8. Furthermore, the pore flanks 8.21, 8.22 may be defined by terrace-like layer steps 8.23 of different widths. In particular, different inclination angles α₁, α₂ can thereby be realised at the respective pore flank 8.21, 8.22.

FIG. 4 schematically illustrates a portion of a panel produced by a preferred embodiment of the method according to the invention, the layers or elements, which correspond to the layers and elements shown in FIG. 3, being designated by the same reference numerals. It can be seen that elongate elevations 8.1 of the areal, three-dimensional structure 8 may be delimited both by elongate indentations (pores) 8.24 and by relatively short, transversely running indentations (pores) 8.25.

The realization of the invention is not limited to the above-described embodiments. Rather, numerous variants are conceivable, which, with differing configuration, also make use of the invention disclosed in the accompanying claims. Thus, for example, it is also within the scope of the invention that a liquid and/or powdery application material is used as the application material, which solidifies under the action of a binder or a component of a binder, in particular a curing agent, the application material applied to the substrate or the decor being solidified in a locally limited manner in the region of the structure to be produced by supplying said binder or a binder component. The binder or a binder component, in particular a curing agent, may, in this case, before and during the application to the liquid or powdery application material, have a liquid consistency and, for example, be applied as a fine liquid jet by means of a digitally controlled spray head.

Basically, it is sufficient if the three-dimensional structure 8 is produced by applying a single layer of application material. In order to achieve a structure 8 having a relatively large structural depth, it is, however, favourable to produce the structure 8 by multi-layer, for example, two-layer or three-layer application of application material.

The application material used to produce the structure 8 may have a powdery and/or liquid consistency during the application phase. In particular, the application material may be applied as a dispersion to the substrate 2 or the printed decor and then be solidified in regions.

If liquid application material is used as the application material, it is preferably applied by means of one or more application rollers to the substrate 2 or the decor. In this case, the application head (spreading head) 7.1 and/or 7.2 is replaced by one or more application rollers.

1. A method for producing a panel, in particular a furniture or floor panel, wherein a decor, preferably a wood imitating decor, is applied to at least one surface of a plate-shaped substrate, and wherein the substrate or the decor is provided with an areal, three-dimensional structure, wherein to produce the structure liquid, powdery, or a combination of liquid and powdery application material is applied in a single layer or multiple layers to the substrate or the decor, in that the application material applied is solidified in regions by means of at least one digitally controllable device, and in that the device is controlled using structural data present in digital form.

2. The method according to claim 1, wherein a liquid, powdery, or a combination of liquid and powdery application material is used as the application material and is solidified under the action of radiation, preferably light thermal radiation, or a combination of light and thermal radiation, the application material applied to the substrate or the decor being solidified in a locally limited manner in the region of the structure to be produced by supplying said radiation.

3. The method according to claim 1, wherein a liquid, powdery, or a combination of liquid and powdery application material is used as the application material and is solidified under the action of a binder or a component of a binder, the application material applied to the substrate or the decor being solidified in a locally limited manner in the region of the structure to be produced by supplying said binder or the binder component.

4. The method according to claim 1, wherein after the locally limited solidification of the application material, non-solidified, excess application material is removed from the plate-shaped substrate.

5. The method according to claim 4, wherein the removed excess application material is reused to produce further structural portions.

6. The method according to claim 1, wherein the decor is printed onto the plate-shaped substrate or onto the three-dimensional structure by means of a digital printing device.

7. The method according to claim 6, wherein digital decor data to control the printing device are obtained by scanning patterns produced from natural products.

8. The method according to claim 1, wherein the structural data are obtained by scanning patterns produced from natural products.

9. The method according to claim 1, wherein the structural data are obtained by scanning the decor applied to the plate-shaped substrate.

10. The method according to claim 1, wherein the structural data are stored in a memory.

11. The method according to claim 1, wherein the application material is applied to the substrate or the decor over the entire area.

12. The method according to claim 1, wherein powdery application material is used as the application material, the powdery application material being applied to the substrate or the decor by means of one or more spreading devices.

13. The method according to claim 1, wherein liquid application material is used as the application material, the liquid application material being applied to the substrate or the decor by means of one or more application rollers.

14. The method according to claim 1, wherein the application material applied is solidified in regions by means of a plurality of digitally controllable devices, the devices covering different surface regions of the substrate.

15. The method according to claim 1, wherein the application material is applied to the substrate or the decor in multiple layers.

16. The method according to claim 1, wherein the application material used contains hard particles.

17. A panel, in particular furniture or floor panel, produced by a method according to claim 1.
